(19) United States
(12) Patent Application Publication
(10) Pub. No.: US 2014/0172539 A1
(43) Pub. Date: Jun. 19, 2014

(54) MEDIA STATION WITH CUSTOM BUMPER

(71) Applicant: APPLE INC., Cupertino, CA (US)

(72) Inventors: Thomas Alsina, Mountain View, CA (US); Eswar Priyadarshan, Los Altos, CA (US); Jayasurya Vadrevu, Saratoga, CA (US)

(73) Assignee: Apple Inc., Cupertino, CA (US)

(21) Appl. No.: 13/715,997

(22) Filed: Dec. 14, 2012

(51) Int. Cl. G06Q 30/02

(52) U.S. Cl. CPC G06Q 30/0277
USPC 705/14.39; 705/14.73; 705/14.66

(57) ABSTRACT

Disclosed herein are systems, methods, and non-transitory computer-readable storage media for providing a custom bumper within a media station. A custom bumper can be created using gathered bumper creation data and a bumper template. Bumper creation data can be any data regarding the media station and can be used to populate an appropriate bumper template. The populated template is a completed custom bumper customized based on the bumper creation data. Further, rewards can be awarded to encourage desired user interactions. Upon a determination that a desired user interaction has occurred a predetermined number of times, a reward can be awarded. The reward can be making available a previously unavailable media item. Bumper creation data indicating the remaining number of times the user interaction has to be performed to achieve the reward to be awarded can be used to create a custom bumper.

### BACKGROUND

1. Technical Field

The present disclosure relates to media stations and more specifically to media stations with custom bumpers.

2. Introduction

Interactive media stations that provide advertisements along with media can sometimes become confusing for a user. Interactive advertisements that can be still be interacted with while a media item is being performed may lead some users to associate the media item with the advertisement. For example, a user may mistakenly believe that the author of the media item is promoting the advertised product. To alleviate this problem, intermediate bumper messages can be used to alert the user that the advertisement has completed and a media item is resuming. Current bumper messages are typically generic messages that are repetitive and not personal to a user. They provide little information other than alerting the user that a change is being made from the advertisement to the media item, or vice versa, and thus provide little value.

Further, current media stations do little to incentivize users to perform desired actions such as interact with advertisements. Accordingly, a need for an improved method of presenting a media station exists.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for providing a custom bumper within a media station. A media station can consist of media items and invitational content items presented in series, in combination, or both. To identify that that an invitational content item is ending and a media item is beginning, an intermediate bumper message can be presented by the media station. For example, the intermediate bumper message can be an audio message such as “and now back to the music.”

The disclosed invention can create a custom bumper that is customized for the media station. The custom bumper can be created using gathered bumper creation data and a bumper template. Bumper creation data can be any data regarding the media station such as data describing invitational content items and media items as well as data gathered from a user account associated with the media station. The gathered bumper creation data can be populated into an appropriate bumper template that can be completed using the bumper creation data to create a custom bumper. For example, a bumper template can be customized with bumper creation data identifying the next media item to be performed. Thus the custom bumper can be an audio message such as “and now a song by the Beatles.” Alternatively, in some embodiments, the custom bumper can be based on bumper creation data about a user. For example, the custom bumper can be customized based on the name of a user. The custom bumper, therefore, can be an audio message such as “and now back to the music Bob.” A bumper template can therefore be customized to create multiple custom bumpers based on the bumper creation data used to create the custom bumper.

In some embodiments, rewards can be awarded to encourage desired user interactions. For example, a desired user interaction can be a user interacting with an item of invitational content presented on the media station. Upon a determination that a desired user interaction has occurred, a reward count associated with the desired user interaction can be incremented. The reward count can thus indicate the number of times the desired user interaction has been performed. The reward count can be compared to a predetermined reward milestone and if the reward count has reached the reward milestone, a reward can be awarded. In some embodiments, the reward can be making available a media item that was not previously available.

Further, bumper creation data indicating the reward count and the reward milestone associated with a desired user interaction can be used to create a custom bumper. For example, the custom bumper can indicate the remaining number of times the user interaction has to be performed to achieve the reward to be awarded. Thus the custom bumper can be an audio message such as “view 3 more advertisements to get a reward, now back to the music.”

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary system embodiment of a computing device;

FIG. 2 illustrates an exemplary system embodiment in which multiple computing devices can be configured to communicate with each other to create and perform a media station on a client device;

FIG. 3 illustrates an exemplary method embodiment of creating a custom bumper; and

FIG. 4 illustrates an exemplary method embodiment of providing a user reward based on desired user interaction with a media station.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

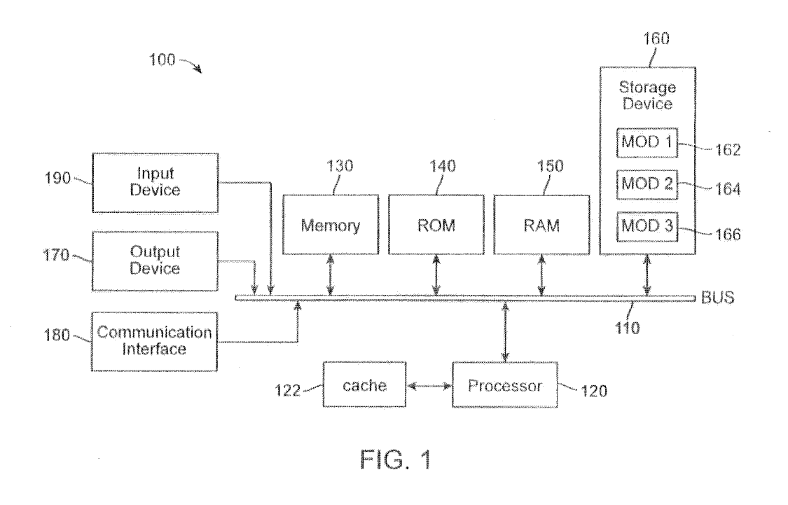

FIG. 1 illustrates an exemplary system 100 that includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache 122 provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example, the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

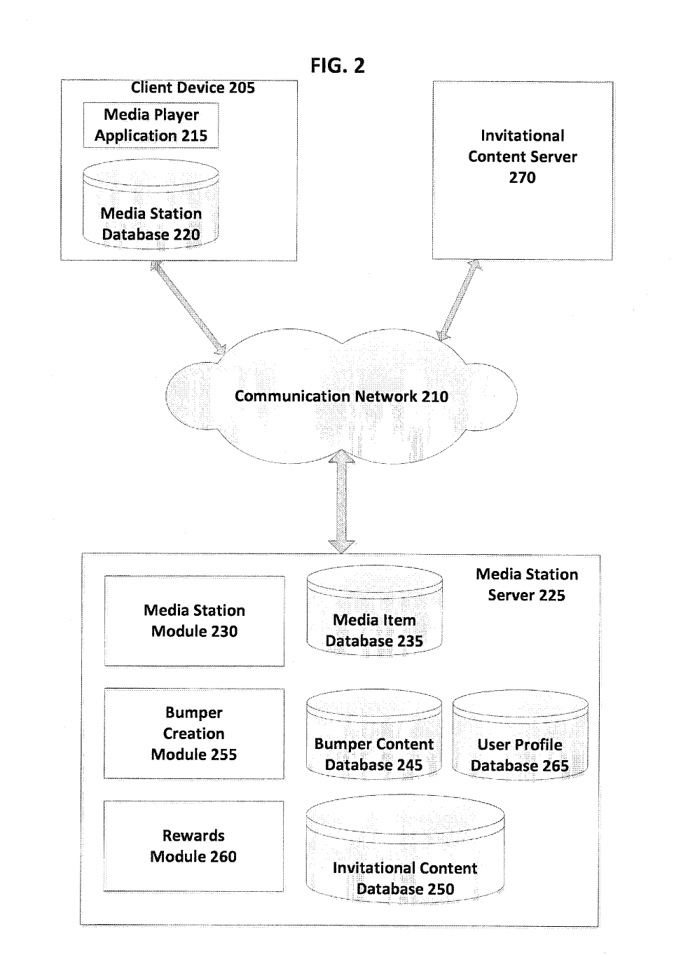

Having disclosed some components of a computing system, the disclosure now turns to FIG. 2, which illustrates an exemplary system embodiment in which multiple computing devices can be configured to communicate with each other to create and perform a media station on a client device. A media station can be a sequence of media items that can be played or executed by a media station player application on a client device. Some non-limiting example of media items can include songs, podcasts, television shows, movies, games, audiobooks, educational courses, and/or video. Other media items are also possible. A media station player can be any application capable of media item playback, such as a component of a webpage, a plug-in, a client-side application, etc.

In some embodiments, a media station can be a continuous sequence of media items such that as one media item completes playback a next media item begins. The playback process of a continuous media item stream can repeat until a user takes an action to terminate or temporarily delay the playback, such as quitting the media player application, switching to a different media station, pausing playback, or skipping a media item. However, a media station can also be defined to be a finite sequence of media items. A media station can be homogeneous or heterogeneous. That is, a media station can be designed to playback media items all of the same media type or of different media types. For example, a homogeneous media station can playback only audio media items or only video media items. In another example, a heterogeneous media station can playback a mix of audio media items and video media items. In some embodiments, the various media items can be presented concurrently such that presentation of one media item overlaps with presentation with a different media item.

A media station can also be configured to play or present invitational content, such as advertisements, within the media stream. An invitational content item can include content found in a media item, such as a song or a video, but an invitational content item can also include targeted content and/or content designed to elicit a response from a user. Therefore an invitational content item and a media item can be distinct item types, each of which can be presented in a media station.

In some embodiments, the invitational content can be used as a source of revenue and/or to subsidize a media station so that the media items can be provided to end users free of charge or for a reduced fee. The invitational content can be presented within a media station using a variety of techniques. In some cases, invitational content can be presented to a user in a manner that prevents or blocks the playback of a next media item or a next segment of a media item. For example, upon the completion of the playback of a music item, but before beginning playback of a new music item, an invitational content item can be presented in the media stream. Invitational content can also be displayed in conjunction with a media item or media item representation. For example, an invitational content item can be presented in a banner ad displayed with a music album cover or during the playback of a television show.

Further, in some embodiments, the invitational content can include an interactive segment that can be presented concurrently with one or more media items. The interactive segment can be configured such that a user can interact with the invitational content without disrupting playback of media items being presented concurrently. A user can thus interact with various features and views of the interactive segment during the playback of a media item without disrupting the media item. For example, in some embodiments, the interactive segment can be a rich media advertisement that includes various views and screens which a user can navigate through while listening to an audio media item.

A downside to presenting both invitational content and media items, either simultaneously or sequentially, when the invitational content is not related to the media items is that a user may equate the media item with the invitational content. For example, a user may think that an invitational content provider endorses a particular media item, or that a media item provider has authorized the use of the media item to promote an offering associated with the invitational content. To decrease the potential for confusion, the media station can also include bumper content, which can be presented concurrently with the interactive invitational content, but just prior to resuming playback of a media item.

A bumper content item can be an intermediary content item that is used to transition from invitational content to a media item, thereby creating user awareness that the media item is not related to an item of invitational content that the user may also be experiencing. For example, a bumper content item can be an audio message such as “now back to the music” that is used to transition between invitational content to an audio media item. Thus a user that is interacting with the interactive segment of an item of invitational content will be made aware that the upcoming media item is not related to the item of invitational content, even though the user is experiencing both concurrently.

To facilitate providing a media station to be performed by a client device, multiple computing devices can be connected to a communication network 210 and configured to communicate with each other through use of the communication network 210. The communication network 210 can be any type of network, including a local area network (“LAN”), such as an intranet, a wide area network (“WAN”), such as the internet, or any combination thereof. Further, the communication network 210 can be a public network, a private network, or a combination thereof. The communication network can also be implemented using any type or types of physical media, including wired communication paths and wireless communication paths associated with one or more service providers. Additionally, the communication network 210 can be configured to support the transmission of messages formatted using a variety of protocols.

A computing device can be any type of general computing device capable of network communication with other computing devices. For example, the computing device can be a personal computing device such as a desktop or workstation, a business server, or a portable computing device, such as a laptop, smart phone, or tablet personal computer. The computing device can include some or all of the features, components, and peripherals of computing device 100 of FIG. 1.

To facilitate communication with other computing devices, the computing device can also include a communication interface configured to receive a communication, such as a request, data, etc., from another computing device in network communication with the computing device and pass the communication along to an appropriate module running on the computing device. The communication interface can also be configured to send a communication to another computing device in network communication with the computing device.

As illustrated, a client device 205 can be configured to communicate with a media station server 225 to perform a media station on the client device 205. For example, a media player application 215 running on the client device 205 can be configured to communicate with a media station module 230 on the media station server 225 to request, receive and perform a media station. A media station player can be any application capable of media item playback, such as a component of a webpage, a plug-in, a client-side application, etc.

The media station module 230 can be configured to create a media station to be performed on a client device. For example, the media station module 230 can be configured to assemble the media station by selecting media items, invitational content items and bumper items to be performed on the client device in a specified order. For example, the media station server 225 can include a media item database 235, a bumper content database 245 and an invitational content database 250, each configured to store multiple media items, bumper content items, and invitational content items respectively. The media station module 230 can be configured to communicate with the databases to select media items, bumper content items and invitational content to be performed as part of the media station.

Although the media item database 235, bumper content database 245 and the invitational content database 250 are illustrated separately, this is just one possible embodiment and is not meant to be limiting. In some embodiments, the databases can be combined as one database or any other possible combination.

Alternatively, in some embodiments, the multiple databases can be hosted on separate computing devices and the media station module 230 can be configured to communicate with the various computing devices to assemble the media station. For example, in some embodiments, the system can include an invitational content server 270 in network communication with the media station server 225 and the media station module 230 can be configured to communicate with the invitational content server 270 to request invitational content to be included in the media station. In some embodiments, the invitational content server 270 can transmit the invitational content to the media station server 225 where it can be assembled into the media station. In some embodiments, the invitational content server 270 can transmit the invitational content directly to the client device 205.

In some embodiments, the media station module 230 can be configured to transmit the assembled media station to the client device 205 where it can be performed by the media player application 215. For example, the media station module 230 can be in continuous communication with the media player application 215 to transmit the media station to be performed by the media player application 215.

In some embodiments, the media station module 230 can be configured to transmit the media station to the client device 205 in segments. For example, the media station module 230 can be configured to communicate with the client device to transmit an assembled segment of the media station which can be stored on the client device 205 and performed by the media player application 215. For example, the client device 205 can include a media station database 220 configured to store the received media station and the media player application 215 can be configured to communicate with the media station database 220 to retrieve the stored media station. In this type embodiment, the media station module 230 can be configured to periodically update the client device 205 by transmitting further assembled segments of the media station.

In some embodiments, the media station can be assembled at the client device 205 rather than at the media station server 225. For example, the media station module 230 can be running on the client device 205 and can be configured to request media items, bumper content items and invitational content from the media station server 225, or any other computing device. The received media items, bumper content items and invitational content can be stored in the media station database 220 and the media station module 230 can be configured to communicate with the media station database 220 to retrieve the stored media items, bumper content items and invitational content to assemble the media station. In this type of embodiment, the media station module 230 running on the client device 205 can be configured to periodically request further media items, bumper content items and invitational content be delivered to the client device.

The media station module 230 can be configured to assemble the media station based upon media station assembly rules. The media station assembly rules can dictate which media items, invitation content items and bumper content items should be selected for the media station as well as the sequential order in which they should be presented by the media player application 215.

In some embodiments, the media station module 230 can request that a custom bumper be created. For example, the media station server 225 can include a bumper creation module 255 configured to create a custom bumper that is customized for the media station in which the custom bumper is presented. For example, a custom bumper can be customized to identify the media item that is presented immediately after the custom bumper is presented in the media station. Thus, the custom bumper can be an audio message such as “now to a song by the Beatles,” that is followed by the song Dig a Pony by the Beatles. The media station module 230 can be configured to transmit a bumper creation request to the bumper creation module 255 to create a custom bumper.

To create a custom bumper, the bumper creation module 255 can be configured to gather bumper creation data that is used to customize the custom bumper. Bumper creation data can be any type of data that is related to the media station. For example, in some embodiments, bumper creation data can include data identifying media items and invitational content items performed as part of the media station. This can include any data such as a name, author, description, date of creation, genre, content provider, etc. regarding a media item or invitational content item. In some embodiments, bumper creation data can include data regarding a user requesting the media station. For example, the bumper creation data can include the user's name, address, phone number, age, nationality, likes, dislikes, previous history interacting with the media station, etc.

The bumper creation module 255 can be configured to use the gathered bumper creation data to create a custom bumper. In some embodiments, the bumper creation module 255 can be configured to use the bumper creation data to populate a bumper template to create a custom bumper. A bumper template can be a bumper that is an incomplete message to which bumper creation data can be appended to create a completed custom bumper. For example, a bumper template can be configured to receive an artist name to complete the custom bumper. Thus, the bumper template can be an incomplete audio message such as “now to a song by” and the artist name can be appended to the end of the audio message to create the completed custom bumper. The bumper template can therefore be used to create any number of custom bumper messages based on the artist name that is appended at the end of the bumper template. In some embodiments, a bumper template can be associated with metadata identifying the type of bumper creation data necessary to properly complete the bumper template. For example, a bumper template that can be customized based on an artist name can be associated with metadata identifying that an artist name should be used to customize the bumper template. The bumper creation module 255 can be configured to use this metadata to properly create a custom bumper. For example, the bumper creation module 255 can use the metadata identifying the necessary bumper creation data to ensure that proper bumper creation data is used to create the custom bumper. Further, in some embodiments, the bumper creation data available may be limited and the bumper creation module 255 can use the metadata associated with a bumper template to identify the bumper templates that can be used based on the limited bumper creation data. For example, if an artist name is the only available bumper creation data, the bumper creation module 255 can use the metadata associated with the bumper templates to identify a bumper template that can be completed with only the artist name.

In some embodiments, the bumper templates can be stored in the bumper content database 245 and the bumper creation module 255 can be configured to access the bumper content database 245 to retrieve the stored bumper templates. Further, bumper creation rules dictating how to create a custom bumper can also be stored in the bumper content database 245. The bumper creation rules can dictate how a bumper template can be selected. The bumper creation module can be configured to use the bumper creation rules to create the custom bumper.

The bumper creation module 255 can be configured to gather bumper creation data from multiple sources. One possible source from which bumper creation data can be gathered is from invitational content items and media items. For example, media items and invitational content items can each be associated with metadata describing the media item or invitational content item. The metadata can include a name, author, description, date of creation, genre, content provider, etc. of the respective invitational content item or media item. The bumper creation module 255 can be configured to gather this metadata to be bumper creation data used to create the custom bumper.

In some embodiments, the bumper creation module 255 can be configured to communicate with the bumper content database 245 and the invitational content database 250 to gather the metadata associated with invitational content items and media items. In some embodiments, the media station module 230 can pass the metadata describing an invitational content item or media item to the bumper creation module 255 when requesting that a custom bumper be created.

Bumper creation data can also be gathered from a user profile. For example, the media station server 225 can include a user profile database 265 configured to store user profile data regarding a user associated with the media station. User profile data can include any variety of data regarding the user such as the user's name, address, likes, dislikes, media previous media station history, etc. The bumper creation module 255 can be configured to communicate with the user profile database 265 to gather bumper creation data regarding a user associated with a media station.

Using an artist name to customize a custom bumper is only one example and is not meant to be limiting. A custom bumper can be customized based on any type of bumper creation data. In some embodiments, the custom bumper can be customized based on an invitational content provider. For example, the custom bumper can identify the invitational content provider associated with the invitational content item that was presented immediately prior to the custom bumper. The custom bumper can therefore be an audio message such as “that message brought to you by advertiser X, now back to the music.”

In some embodiments, the custom bumper can be customized based on a user's name. For example, the custom bumper can be an audio message such as “now back to the music Bob.”

In some embodiments, the custom bumper can be customized based on a user's likes. For example, a custom bumper can be an audio message such as “now one of your favorite songs.”

In some embodiments, the custom bumper can be customized based on multiple pieces of bumper creation data. For example, a custom bumper can be customized based on a user's name, the user's likes, the title and artist of the next media item to be performed. Thus a custom bumper can be an audio message such “Bob, now one of your favorite songs, Dig a Pony by the Beatles.”

In some embodiments, the custom bumper can be customized based on the upcoming media item and an interactive item of invitational content being presented concurrently with the upcoming media item. For example, the custom bumper can be an audio message such as “now a song by the Beatles while you enjoy a game brought to you by Advertiser X.”

In some embodiments, the custom bumper can be customized based on current news events. For example, bumper creation data can be gathered from a 3^{rd} party news source and used to create the custom bumper. Thus the custom bumper can be an audio message such as “President Obama defeats Mitt Romney in the presidential election, now back to the music.”

Alternatively, a custom bumper can be customized based on bumper creation data gathered from a sports news source to alert the user to current sport scores and updates. For example, the custom bumper can be an audio message such as “The Raiders have just won the Superbowl, now back to the music.” In some embodiments, the custom bumper can be customized based on bumper creation data gathered from a music news source and can alert the user to music updates. For example, a custom bumper can alert the user that a new album is being released. Thus the custom bumper can be an audio message such as “now to Dig A Pony by the Beatles, which is available on their Greatest Hits albums that will be released this Thursday.”

Alternatively, in some embodiments, the custom bumper can alert a user of upcoming concerts in the user's area. For example, user profile data identifying the city the user lives in can be used to select the appropriate bumper creation data for the user from a music news source. Thus, the user's city can be used to select the bumper creation data identifying the dates that an artist is performing live in the city the user lives in. For example, the custom bumper can be an audio message such as “now to a song by Justin Beiber who is performing live in San Francisco on December 25^{th}.”

In some embodiments, the custom bumper can be customized based on recent updates on a social networking site. For example, bumper creation data can be gathered from a social networking profile associated with the user. The user's social networking account can be accessed to retrieve recent activity on the social networking site to be used as bumper creation data. For example, the bumper creation data can be recent updates on the user's newsfeed on the social networking site such as liking an artist. Thus the custom bumper can be an audio message made by an artist liked by the user, such as “now back to the music.” In some embodiments, the custom bumper can alert the user to recent updates made by the user's friends on the social networking site. For example, the custom bumper can be an audio message such as “Bob just posted pictures from Hawaii, now back to the music.”

In some embodiments, the custom bumper can be customized to alert the user to a promotion regarding to a media item being performed in the media station. For example, promotional data can be gathered from an online media store and used as bumper creations data. The promotional data along with data identifying the upcoming media item can be used to create a custom bumper alerting the user to a promotion for the media item. Thus the custom bumper can be an audio message such as “now back to the music with Can't Buy Me Love which is currently half off in the media store.”

Alternatively, in some embodiments, the custom bumper can identify the price of the media item, regardless of whether there is a promotion for the media item. Thus the custom bumper can be an audio message such as “now back to the music with Can't Buy Me Love which is currently on sale for $0.99 in the media store.

These are just a few examples and are not meant to be limiting. One skilled in the art would recognize that a custom bumper can be customized based on any item or items of bumper creation data.

In some embodiments, the custom bumper can be used to notify the user about the user's progress towards achieving a reward. For example, the media station server 225 can include a rewards module 260 configured to monitor user interactions with the media station to determine whether the user has performed a requisite number of desired user interactions to achieve an award. A desired user interaction can be any user interaction with the media station. For example, the desired user interaction can be remaining logged into the media station for a predetermined amount of time, interacting with an item of invitational content, purchasing a media item performed on the media station, purchasing an item associated with an item of invitational content performed on the media station, etc.

The rewards module 260 can be configured to monitor the user's interactions for any of the desired user interactions. Upon receiving an input indicating that a desired user interaction has been performed, the rewards module 260 can be increment a reward count associated with the desired user interaction. The reward count can be an integer used to indicate the number of times the user has performed the desired user interaction.

The rewards module 260 can use the reward count to determine whether the user has achieved a reward. For example, the reward count can be compared to a predetermined award milestone to determine whether the user has achieved an award. If the award count has reached the award milestone, the rewards module 260 can unlock a reward for the user.

In some embodiments, the reward can be presenting the user with a media item that was previously unavailable to the user. For example, the reward can be a media item that is associated with a higher royalty fee. In some embodiments, the reward can be a unique media item such as a live version of a song or special recording unique to the media station.

The bumper creation module can be configured to gather bumper creation data indicating the user's progress in achieving a reward and use the data to create a custom bumper that alerts the user of the user's progress. For example, the award count can be stored in the user profile database 265 and associated with the user. The bumper creation module 255 can be configured to gather the reward count and the award milestone as bumper creation data to create a custom bumper alerting the user of their progress. For example, a custom bumper can be an audio message such as “interact with 2 more advertisements to unlock the reward song.” Alternatively, in some embodiments, the custom bumper can alert the user as to which items of invitational content are associated with an award. For example, a custom bumper can be an audio message such as “look for advertisements from Advertiser X to unlock the reward song.”

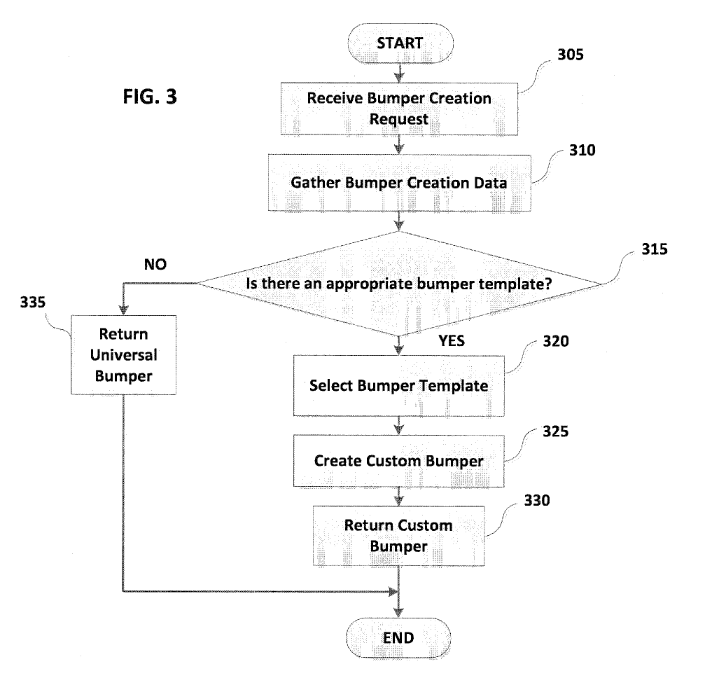

FIG. 3 illustrates an exemplary method embodiment of creating a custom bumper. As illustrated, the method begins at block 305 where a bumper creation request is received. Upon receiving the bumper creation request, the method continues to block 310 were bumper creation data is gathered. Bumper creation data can be any data regarding the media station. For example, bumper creation data can be data regarding invitational content items and media items performed on the media station. Alternatively, bumper creation data can be data regarding a user associated with the media station. In some embodiments, bumper creation data can be data gathered from a 3^{rd} party source such as a new source or social networking site. For example, the bumper creation data can be current news stories. Alternatively, the bumper creation data can be recent updates to a user's news feed on a social networking site.

In some embodiments, the bumper creation data can be received as part of the bumper creation request. Alternatively, in some embodiments, bumper creation data can be gathered from metadata associated with invitational content items and media items included in the media station. In some embodiments, bumper creation data can be gathered from a user profile associated with the media station.

Upon gathering the bumper creation data, the method continues to block 315 where it is determined if there are any appropriate bumper template based on the gathered bumper creation data. For example, metadata associated with the bumper templates can be analyzed to determine which bumper templates can be used based on the gathered bumper creation data. If there are no appropriate bumper templates available, the method continues to block 335 where a universal bumper that is not customized is returned to be used in the media stream and the method ends.

In some embodiments, there can be a different selection of bumper templates based on various factors. For example, different selections of bumper templates can be available depending on the geographic location of the client device, the time of day or time of year, the type of client device, the network connection associated with the client device, user interests, music genre of the media station, etc.

If at block 315 it is determined that there are appropriate bumper templates, the method continues to block 320 where one of the appropriate bumper templates is selected. One of the appropriate bumper templates can be selected in any number of ways known in the art. For example, in some embodiments, one of the appropriate bumper templates can be selected by random.

In some embodiments, one of the appropriate bumper templates can be selected based upon a predetermined order assigned to the bumper templates. For example, the bumper templates can be assigned a specified order in which to be selected and the available one of the appropriate bumper templates that is assigned to be next in the order can be selected.

In some embodiments, the bumper templates can be categorized and the one of the appropriate bumper templates can be selected based on the available categories of appropriate bumper templates. For example, each category of bumper template can be ranked and an appropriate bumper template from the available category ranked the highest can be selected. Alternatively, an appropriate bumper template can be selected from one of the available bumper template categories based on a predetermined order assigned to the bumper categories.

In some embodiments, one of the appropriate bumper templates can be selected based upon feedback gathered from a user. For example, user interaction with the media station, including amount of time spent on the media station, interaction with invitational content items, interactions with controls provided by the media station, etc. can be monitored and used to determine the impact of the different categories of bumper templates on the user's interaction with the media station. This feedback can be used to select an appropriate bumper template to result in a desired action by the user. For example, feedback that a user often increases the volume after being presented with a bumper in which the next media item is identified can indicate that the user reacts positively to this category of bumper and is more likely to listen to the following media item when presented with a bumper from this category. Accordingly, to elicit longer interaction time and positive of response from a user, an appropriate bumper template from this category can be selected. As another example, feedback that a user interacts with the next available item of invitational content upon being presented with a bumper updating the user's progress in achieving a reward can indicate that to elicit a user response of interacting with invitational content, a bumper template from this category should be selected.

In some embodiments, one of the bumper templates can be selected based on information known about the user. For example, a bumper template can be selected based on the user's likes such that the custom bumper relates to the user's likes. For example, a custom bumper that uses bumper creation data regarding current sports scores can be selected when based on a user's profile it is known that the user likes sports.

These are just a few examples of how a bumper template can be selected and are not meant to be limiting. One skilled in the art would recognize that a bumper template can be selected in any number of ways know in the art.

Upon selecting one of the appropriate bumpers, the method continues to block 325 were the custom bumper is created. This can include appending the bumper creation data to the bumper template. In some embodiments, this can also include converting the bumper creation data to a format compatible with the bumper template. For example, in embodiments where the bumper template is an audio message, the bumper creation data to be appended to the bumper template can be converted to an audio format. To accomplish this, in some embodiments, a voice conversion program configured to convert text to audio can be utilized to convert text to audio. Alternatively, in some embodiments, the bumper creation data can already be in a format compatible with the bumper template and no conversion is necessary. In some embodiments, the appropriate converted format can be selected from an available database of available converted bumper creation data. For example, a database of common words in audio format can be used to select the appropriate conversion of the bumper creation data. If the appropriate conversion is not available, in some embodiments an alternate similar word can be selected. In some embodiments, a universal bumper can be returned if no appropriate conversion is available.

Upon creating the custom bumper, the method continues to block 330 where the custom bumper is returned in response to the bumper creation request and the method ends.

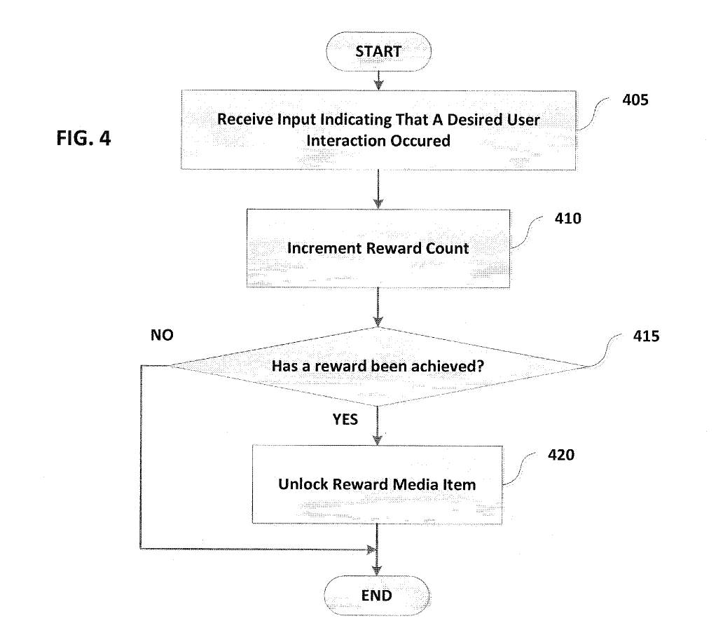

FIG. 4 illustrates an exemplary method embodiment of providing a user reward based on desired user interaction with a media station. As illustrated, the method begins at block 405 where an input indicating that a desired user interaction has been performed is received. A desired user interaction can be any type of user interaction with a media station that is predetermined to be a desired user interaction. For example, a desired user interaction can be interacting with an item of invitational content in the media station, interacting with the media station for a desired amount of time, purchasing a media item performed on the media station, purchasing an item advertised by an item of invitational content, providing requested feedback, etc.

Upon receiving the input indicating that a desired user interaction has been performed, the method continues to block 410 where a reward count associated with the desired user interaction is incremented. The reward count can be an integer that indicates the number of times that the desired user interaction associated with the reward count has been performed by the user. There can be multiple reward counts, each associated with a different desired user interaction.

The method then continues to block 415 where it is determined whether a reward has been achieved. In some embodiments, this can be determined by comparing the incremented reward count to a predetermined milestone number associated with the desired user interaction. If, based on the incremented reward count, it is determined that the user has performed the desired user interaction the number of times dictated by the predetermined milestone number, it is determined that the user has achieved a reward. The method continues to block 420 where the reward is unlocked and presented to the user. If at block 415 it i9s determined that the user has not performed the desired user interaction enough times to meet the predetermined milestone number, the user has not achieved a reward and the method ends.

In some embodiments, unlocking the reward 420 can include making available to the user a media item previously unavailable to the user. For example, the unlocked media item can be unique media item such as a live performance of a song or an exclusive recording unique to the media station. Alternatively, the unlocked media item can be a media item associated with a higher royalty fee. In some embodiments, the unlocked media item can be a video game.

In some embodiments, the unlocked media item can be performed once for the user. in some embodiments, the user maintains access to the unlocked media item and it can be included in the pool of media items presented as part of the media station.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A method, comprising:
gathering bumper creation data relating to a media station being performed on a media device associated with a user;
identifying, from a plurality of available bumper templates and based at least on the bumper creation data, a portion of the plurality of bumper templates to yield identified bumper templates to use with the bumper creation data to create a custom bumper;
selecting one of the identified bumper templates to yield a selected bumper template;
creating the custom bumper for the media station using the bumper creation data and the selected bumper template.

2. The method of claim 1, wherein the bumper creation data comprises metadata associated with a media item performed on the media station.

3. The method of claim 1, wherein the custom bumper identifies the next media item to be performed on the media station.

4. The method of claim 1, wherein the bumper creation data is gathered from a user profile associated with at least one of the media station or the media device.

5. The method of claim 1, further comprising:
determining that a desired user interaction has been performed in regards to the media station;
incrementing a reward count associated with the desired user interaction, the reward count indicating the number of times the desired user interaction has been performed; and
upon a determination that the reward count has met a reward milestone, unlocking a reward associated with the user account.

6. The method of claim 5, wherein the reward is making available to the media station a media item that was previously unavailable.

7. The method of claim 6, wherein the bumper creation data identifies a number of times a desired user interaction has been performed in regards to the media station and a milestone number of times the desired user interaction has to be performed to achieve a reward.

8. The method of claim 7, wherein the custom bumper identifies a remaining number of times the desired user interaction has to be performed to achieve the reward.

9. The method of claim 1, wherein the custom bumper identifies an invitational content provider associated with an invitational content item performed on the media station.

10. The method of claim 1, wherein the identified bumper templates are bumper templates that can be completed using the gathered bumper creation data.

11. The method of claim 1, wherein the selecting is based on feedback gathered from the media station, the feedback indicating an anticipated user response to the selected bumper template.

12. The method of claim 1, wherein the selecting is based upon a predetermined order assigned to the identified bumper templates.

13. A system, comprising:
a processor; and
a memory containing instruction that, when executed, cause the processor to:
gather bumper creation data relating to a media station being performed on a media device associated with a user;
identify, from a plurality of available bumper templates and based at least on the bumper creation data, a portion of the plurality of bumper templates to yield identified bumper templates to use with the bumper creation data to create a custom bumper;
select one of the identified bumper templates to yield a selected bumper template;
creating the custom bumper for the media station using the bumper creation data and the selected bumper template.

14. The system of claim 13, wherein the bumper creation data comprises metadata associated with a media item performed on the media station.

15. The system of claim 13, wherein the custom bumper identifies the next media item to be performed on the media station.

16. The system of claim 13, wherein the bumper creation data is gathered from a user profile associated with at least one of the media station or the media device.

17. The system of claim 13, wherein the instructions further cause the processor to:
determine that a desired user interaction has been performed in regards to the media station;
increment a reward count associated with the desired user interaction, the reward count indicating the number of times the desired user interaction has been performed; and
upon a determination that the reward count has met a reward milestone, unlock a reward associated with the user account.

18. The system of claim 17, wherein the reward is making available to the media station a media item that was previously unavailable.

19. The system of claim 18, wherein the bumper creation data identifies a number of times a desired user interaction has been performed in regards to the media station and a milestone number of times the desired user interaction has to be performed to achieve a reward.

20. The system of claim 19, wherein the custom bumper identifies a remaining number of times the desired user interaction has to be performed to achieve the reward.

21. The system of claim 13, wherein the custom bumper identifies an invitational content provider associated with an invitational content item performed on the media station.

22. The system of claim 13, wherein the identified bumper templates are bumper templates that can be completed using the gathered bumper creation data.

23. The system of claim 13, wherein the selecting is based on feedback gathered from the media station, the feedback indicating an anticipated user response to the selected bumper template.

24. The system of claim 13, wherein the selecting is based upon a predetermined order assigned to the identified bumper templates.

25. A non-transitory computer-readable medium containing instructions that, when executed by a computing device, cause the computing device to:
gather bumper creation data relating to a media station being performed on a media device associated with a user;
identify, from a plurality of available bumper templates and based at least on the bumper creation data, a portion of the plurality of bumper templates to yield identified bumper templates to use with the bumper creation data to create a custom bumper;
select one of the identified bumper templates to yield a selected bumper template;
create the custom bumper for the media station using the bumper creation data and the selected bumper template.

26. The non-transitory computer-readable medium of claim 25, wherein the bumper creation data comprises metadata associated with a media item performed on the media station.

27. The non-transitory computer-readable medium of claim 25, wherein the custom bumper identifies the next media item to be performed on the media station.

28. The non-transitory computer-readable medium of claim 25, wherein the bumper creation data is gathered from a user profile associated with at least one of the media station or the media device.

29. The non-transitory computer-readable medium of claim 25, wherein the instructions further cause the computing device to:
determine that a desired user interaction has been performed in regards to the media station;
increment a reward count associated with the desired user interaction, the reward count indicating the number of times the desired user interaction has been performed; and
upon a determination that the reward count has met a reward milestone, unlock a reward associated with the user account.

30. The non-transitory computer-readable medium of claim 39, wherein the reward is making available to the media station a media item that was previously unavailable.

31. The non-transitory computer-readable medium of claim 30, wherein the bumper creation data identifies a number of times a desired user interaction has been performed in regards to the media station and a milestone number of times the desired user interaction has to be performed to achieve a reward.

32. The non-transitory computer-readable medium of claim 31, wherein the custom bumper identifies a remaining number of times the desired user interaction has to be performed to achieve the reward.

33. The non-transitory computer-readable medium of claim 25, wherein the custom bumper identifies an invitational content provider associated with an invitational content item performed on the media station.

34. The non-transitory computer-readable medium of claim 25, wherein the identified bumper templates are bumper templates that can be completed using the gathered bumper creation data.

35. The non-transitory computer-readable medium of claim 25, wherein the selecting is based on feedback gathered from the media station, the feedback indicating an anticipated user response to the selected bumper template.

36. The non-transitory computer-readable medium of claim 25, wherein the selecting is based upon a predetermined order assigned to the identified bumper templates.
